(19) United States
(12) Patent Application Publication
(10) Pub. No.: US 2017/0021778 A1
(43) Pub. Date: Jan. 26, 2017

(54) PANEL AND METHOD OF MAKING AND USING THE SAME

(71) Applicant: GM Global Technology Operations LLC, Detroit, MI (US)

(72) Inventors: Steven C. Lang, Columbus, MI (US); Nilesh D. Mankame, Ann Arbor, MI (US)

(21) Appl. No.: 14/808,285

(22) Filed: Jul. 24, 2015

(51) Int. Cl. B60R 13/02; B29C 35/08

(52) U.S. Cl. CPC B60R 13/02; B29C 35/0805; B29C 2035/0827; B29K 2105/0002

(57) ABSTRACT

A number of variations may include a panel comprising a skin and an interior wherein the interior comprises a microtruss.

### TECHNICAL FIELD

The field to which the disclosure generally relates to includes components for forming structures including, but not limited to, vehicle interiors and exteriors.

### BACKGROUND

Currently, some vehicles use injection molded polymer interior trim panels.

### SUMMARY OF ILLUSTRATIVE VARIATIONS

A number of variations may include a product having a panel comprising a skin and an interior wherein the interior comprises a microtruss.

A number of variations may include a method including providing a skin; and forming an interior comprising a microtruss on the skin to form a panel.

Other illustrative variations within the scope of the invention will become apparent from the detailed description provided hereinafter. It should be understood that the detailed description and specific examples, while disclosing optional variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1A illustrates a panel according to a number of variations.

FIG. 1B illustrates a panel according to a number of variations.

FIG. 1C illustrates a panel according to a number of variations.

FIG. 2 illustrates a panel according to a number of variations.

FIG. 3 illustrates a system and method according to a number of variations.

FIG. 4 illustrates a method according to a number of variations.

FIG. 5 illustrates a method according to a number of variations.

FIG. 6 compares a performance attribute for a sandwich panels with different core materials according to a number of variations.

FIG. 7A1 illustrates a panel and a number of methods according to a number of variations.

FIG. 7A2 illustrates a panel and a number of methods according to a number of variations.

FIG. 7A3 illustrates a panel and a number of methods according to a number of variations.

FIG. 7A4 illustrates a panel and a number of methods according to a number of variations.

FIG. 7A5 illustrates a panel and a number of methods according to a number of variations.

FIG. 7A6 illustrates a panel and a number of methods according to a number of variations.

FIG. 7A7 illustrates a panel and a number of methods according to a number of variations.

FIG. 7A8 illustrates a panel and a number of methods according to a number of variations.

FIG. 7A9 illustrates a panel and a number of methods according to a number of variations.

FIG. 7A10 illustrates a panel and a number of methods according to a number of variations.

FIG. 7B1 illustrates a panel and a number of methods according to a number of variations.

FIG. 7B2 illustrates a panel and a number of methods according to a number of variations.

FIG. 7B3 illustrates a panel and a number of methods according to a number of variations.

FIG. 7B4 illustrates a panel and a number of methods according to a number of variations.

FIG. 7B5 illustrates a panel and a number of methods according to a number of variations.

FIG. 701 illustrates a panel and a number of methods according to a number of variations.

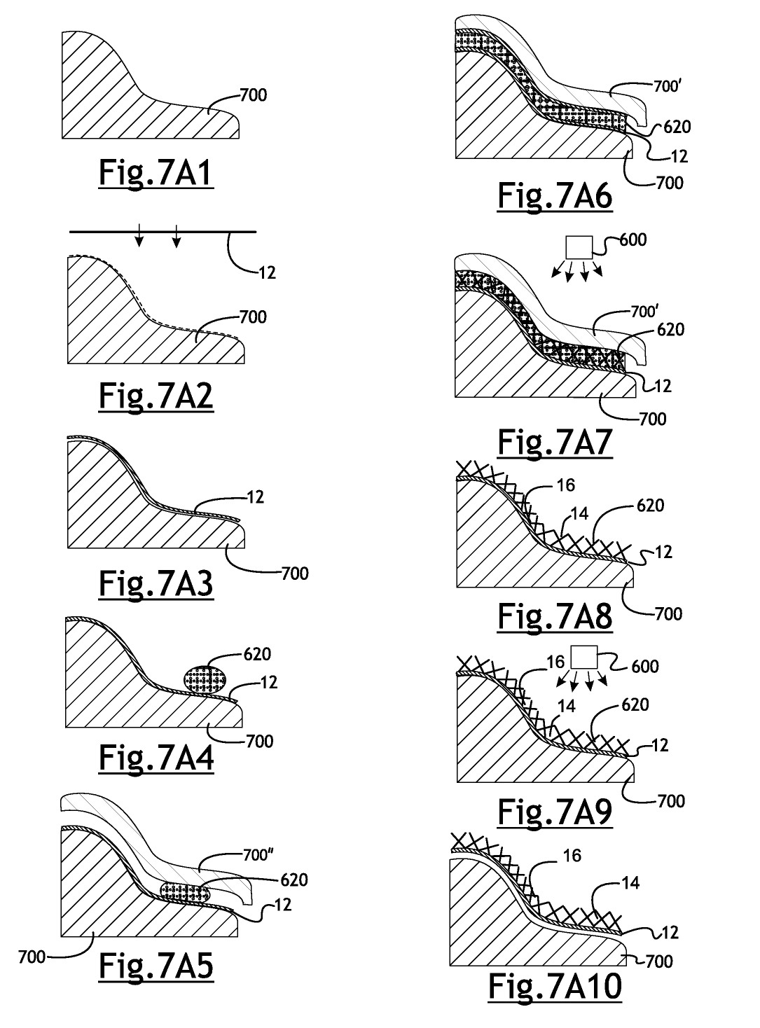

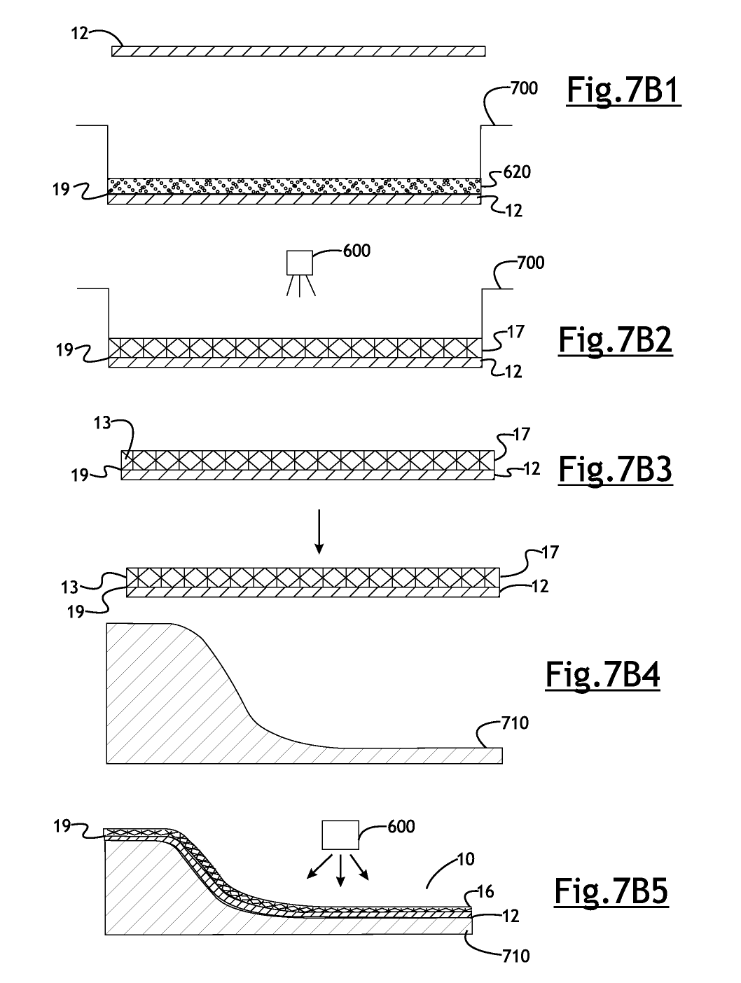

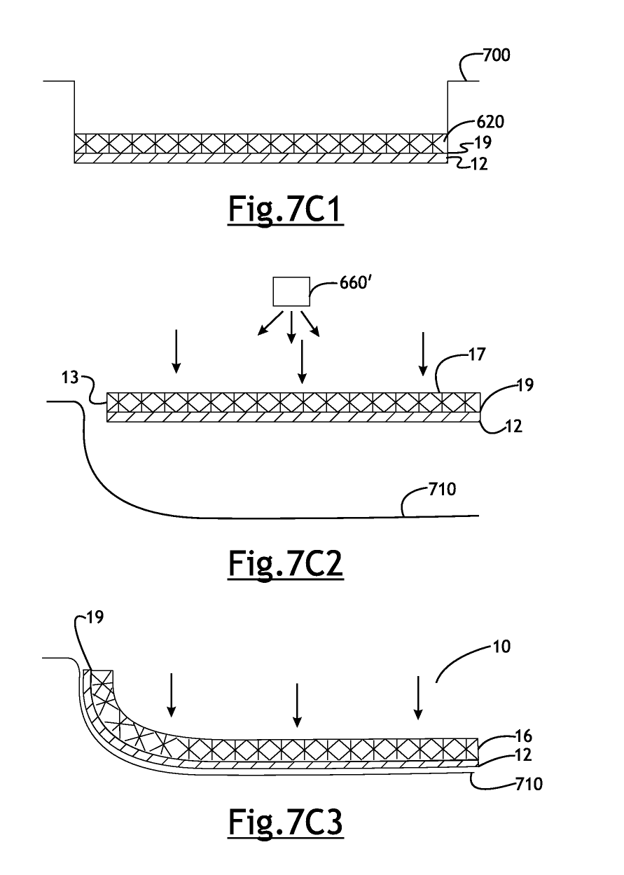

FIG. 7C2 illustrates a panel and a number of methods according to a number of variations.

FIG. 7C3 illustrates a panel and a number of methods according to a number of variations.

### DETAILED DESCRIPTION OF ILLUSTRATIVE VARIATIONS OF THE INVENTION

The following description of the variations is merely illustrative in nature and is in no way intended to limit the invention, its application, or uses.

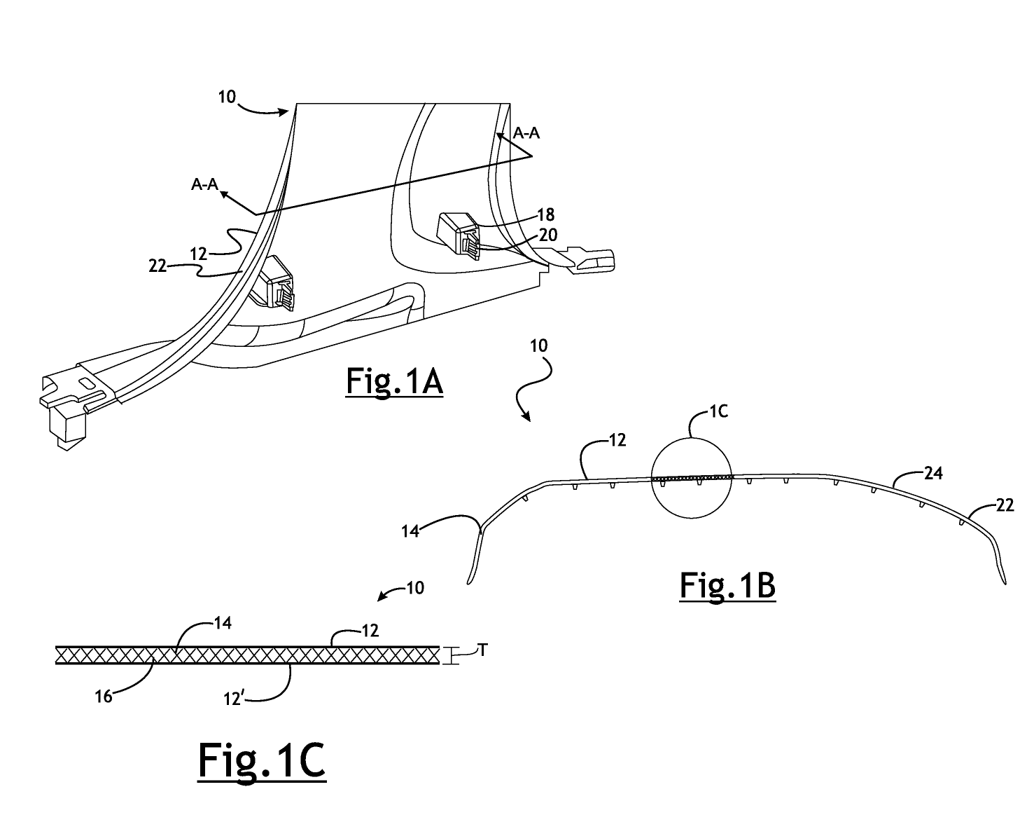

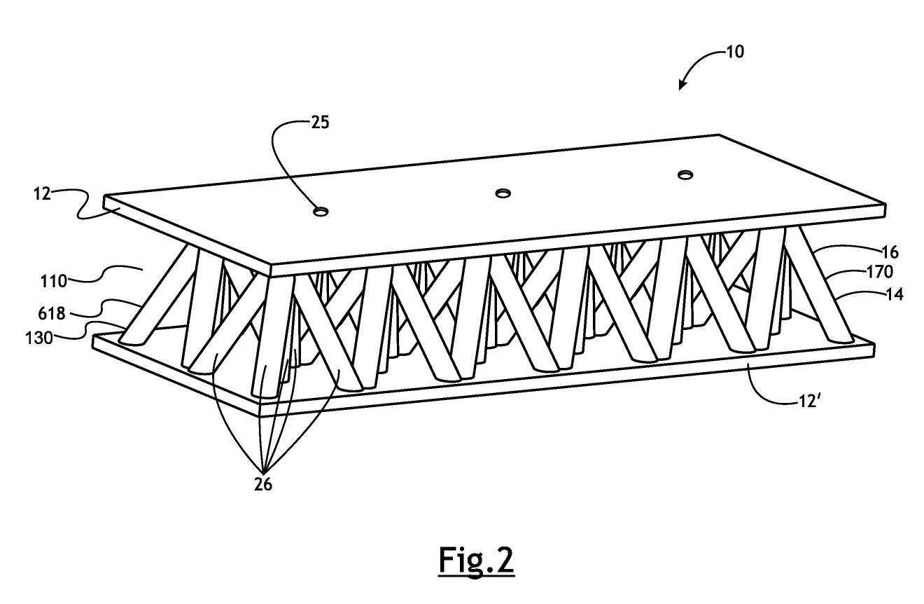

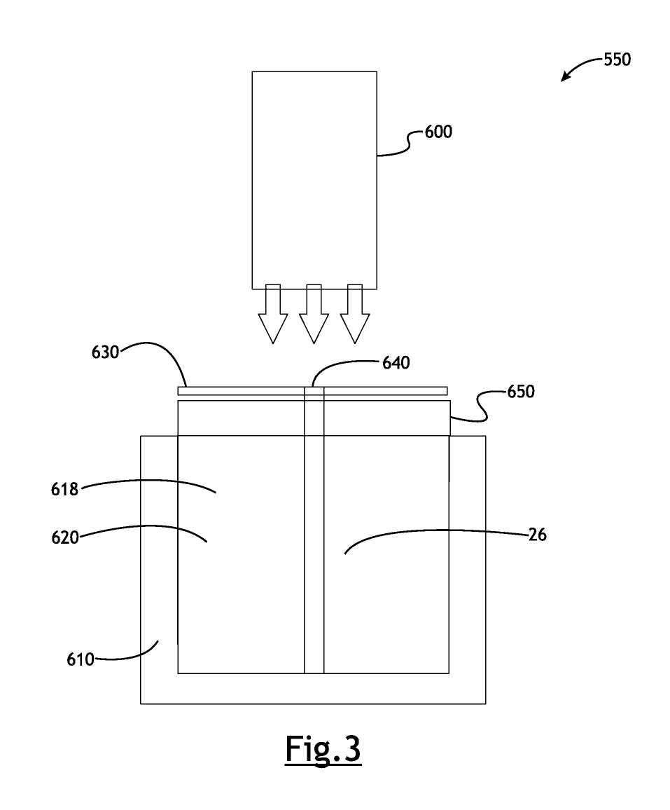

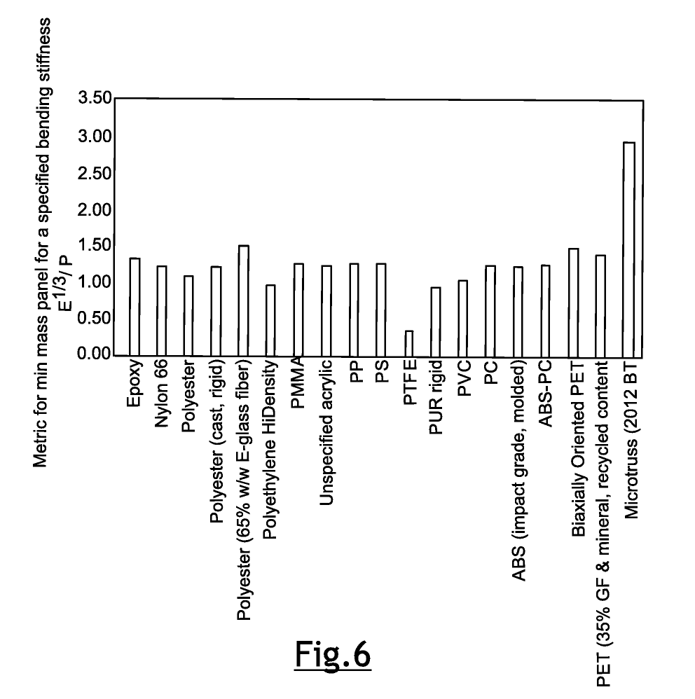

FIGS. 1A-10 illustrate a product 10 according to a number of variations. In a number of variations, the product 10 may include a panel (10). FIG. 1A shows a panel 10 according to a number of variations. FIG. 1B shows a panel 10 cross-section along line/section A-A in FIG. 1A. FIG. 1C shows a close-up of the cross-section of the panel 10 along line/section A-A in FIG. 1B around circle 10. In a number of variations, the panel 10 may form a part of the interior or exterior of a vehicle. In a number of variations, the panel 10 may be trim panel, cover, side panel, exterior panel, upper t-bone, upper interior, or may be another type. In a number of variations, the vehicle may include a motor vehicle, watercraft, spacecraft, aircraft, or may be another type. In a number of variations, the panel 10 may comprise at least one skin 12 and at least one interior 14. In a number of variations, the interior 14 may comprise a microtruss 16. In a number of variations, the interior 14 may comprise a sealing layer 19 between the skin 12 and the microtruss 16. In a number of variations, the sealing layer 19 may prevent the microtruss 16 from seeping into the skin 12 during the fabrication process. In a number of variations, the microtruss 16 may comprise a polymeric material 618. In a number of variations, the microtruss 16 may be uniform throughout. “Uniform” may be defined as being of one material composition or consistency. In a number of variations, the microtruss 16 may be non-uniform. In a number of variations, the polymeric material may be defined by a plurality of self-propagating polymer optical waveguides 26 (FIGS. 2-3). In a number of variations, the skin 12 may comprise a fabric. In a number of variations, the panel 10 may comprise at least one attachment component 18. In a number of variations, the panel 10 may comprise at least one fastener 20. In a number of variations, the panel 10 may have at least one curved portion 22 and at least one planar portion 24. In a number of variations, the interior 14 may have a thickness (T) of less than 1 millimeter. In a number of variations, the skin 12 may have a thickness of less than 0.5 millimeters. In a number of variations, the interior 14 may be formed on the skin 12. In a number of variations, the forming may encompass the interior 14, polymeric material 618, or microtruss 16 being bonded to or grown on the skin 12. In a number of variations, the interior 14 may have a varying thickness throughout. In a number of variations, the panel 10 may be multicolored. In a number of variations, the panel 10 comprising a microtruss 16 may be made to have higher stiffness per unit mass than injection molded panels, higher strength per unit mass than injection molded panels, be lighter weight (by about 10-50%) than injection molded panels, and have customizable energy absorption based on the panel's application. FIG. 6 shows a bending stiffness metric for minimum mass sandwich panels 10 comparing microtruss core 16 to several alternative core materials.

In a number of variations, the skin 12 may comprise a fabric or textile. In a number of variations, the skin 12 may comprise a metal. In a number of variations, the skin 12 may comprise a ceramic. In a number of variations, the skin 12 may comprise a polymer. In a number of variations, the skin 12 may comprise a non-conducting material. In a number of variations, the skin 12 may comprise a material including, but not limited to, plastic steel, stainless steel, copper, nickel, tin, noble metals, zinc, iron, bronze, aluminum, titanium, platinum, shellac, amber, aramid (including Twaron, Kevlar, Technora, Nomax), silk, leather, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof, or may be another type. In a number of variations, the skin 12 may include a composite laminate comprising several layers of the materials listed. In a number of variations, the microtruss 16 is shown in FIGS. 2-3. In a number of variations, the microtruss 16 may comprise a metallic material comprising at least one of aluminum, titanium, tungsten, nickel, tin, platinum, palladium, copper, steel, molybdenum, gold, or silver. In a number of variations, the microtruss 16 may comprise a polymeric material 618 which may comprise a photo-polymeric material 130. In a number of variations, the polymeric material 618 may be coated by a metallic material. In a number of variations, the photo-polymer material 130 may be originally formed from or may comprise a monomer 620. In a number of variations, the microtruss 16 may have a plurality of angled struts or polymer optical waveguides 26 (which may also be referred to as angled “truss elements,” or “truss members,”). In a number of variations, the struts may be formed from the polymer optical waveguides 26. In a number of variations, the microtruss 16 may be formed by using a fixed light or heat input 600 (may be collimated UV light) to cure (polymerize) polymer optical waveguides 26, which may self-propagate in a 3D pattern. As such, the propagated polymer optical waveguides 26 form a microtruss structure 110 comprising the polymeric material 618. In a number of variations, a continuous microtruss 16 photo-polymer material 130 or monomer 620 may be continuously formed such that it lacks any interior boundaries, e.g., boundaries within the interpenetrating portions of microtruss struts. Each node 120 of the microtruss structure 110 may be formed of the continuous microtruss 16 photo-polymer material 130 or monomer 620.

In a number of variations, the photo-polymer material 130 may include a plurality of (a) unsaturated molecules, (b) a molecule having a structure of R—X—H (e.g., X═O, S, N), and (c) a photoinitiator at more than 0% and less than 10% of total weight of the polymer. In a number of variations, the unsaturated molecules may be between 3% and 97% by weight of the monomeric formulation 620. In a number of variations, the molecule having a structure of R—X—H (e.g., X═O, S, N) may be about 3-97% by weight

Regarding component (a), in a number of variations, each of the unsaturated molecules may include C=X2 double bonds or C=X2 triple bonds, wherein X2 may be selected from a group comprising C, N, O, and S. In a number of variations, the C=X2 double bonds or C≡X2 triple bonds may be located at terminal positions of a corresponding one of the unsaturated molecules. In a number of variations, the substitution on the multiple bonds may be any atoms such as H, F and Cl, or groups such as alkyl groups, esters, amine groups, hydroxyl groups and CN. In a number of variations, one or more of these double bonds or triple bonds may be present in the unsaturated molecules. In a number of variations, they may contain different combination of these different multiple bonds.

In a number of variations, each of the unsaturated molecules (a) may include one or more different vinyl groups. In a number of variations, these vinyl groups may be located at the terminal positions. In a number of variations, the unsaturated molecules may be selected from a group comprising ethynyl, cyanide, vinyl ether, vinyl ester, vinyl amides, vinyl triazine, vinyl isocyanurate, acrylate, methacrylate, diene, and triene. In a number of variations, the unsaturated molecules may be selected from a group comprising pentaerythritol tetraacrylate; 2, 4, 6-triallyloxy-1, 3, 5-triazine; triallyl-1, 3, 5-triazine-2, 4, 6-trione; and tricyclohexane.

Regarding component (b), in a number of variations, the molecule having a structure of R—X1-H may be between about 3% and about 97% by weight of the monomeric formulation 620. In a number of variations, the molecule having a structure of R—X1-H may include a part of an organic group. The part of an organic group may include a part of an alkyl group, ester group, amine group, and/or hydroxyl group.

Regarding component (c), in a number of variations, the photoinitiator may be more than 0% and less than about 10% of total weight of the monomeric formulation 620. In a number of variations, the photoinitiator may generate free radicals under a light exposure by one of intramolecular bond cleavage or intermolecular hydrogen abstraction. In a number of variations, the photoinitiator may be selected from a group comprising 2, 2-dimethoxy-2-phenylacetophenone; 2-hydroxy-2-methylpropiophenone; camphorquinone; benzophenone; and benzoyl peroxide.

In a number of variations, the monomeric formulation 620 may further include a free radical inhibitor component (d). In a number of variations, component (d) may be a free radical inhibitor which may be added to the monomeric formulation 620 to help reduce unwanted polymerization of the regions outside the optical waveguide 26. Polymerization of the unexposed regions outside the waveguide 26 may occur from residual heat generated from the polymerization reaction or from light that “leaks out” of the waveguide 26 during light exposure. In a number of variations, the free radical inhibitor (d) may be selected from a group comprising hydroquinone, methylhydroquinone, ethylhydroquinone, methoxyhydroquinone, ethoxyhydroquinone, monomethylether hydroquinone, propylhydroquinone, propoxyhydroquinone, tert-butylhydroquinone, and n-butylhydroquinone. In a number of variations, component (d) may be between 0-3% by weight of the total monomeric material composition 620. In a number of variations, the microtruss 16 photopolymer material 130 components may be mixed into a monomeric formulation 620 including at least some of the components (a), (b), (c), and/or (d). In a number of variations, the components may be thoroughly stirred or blended to make sure they may be well mixed and the monomeric formulation 620 may be uniform.

In a number of variations, a light input 600 (may be collimated ultraviolet light) may be used to cure (polymerize) polymer optical waveguides 26 to form the microtruss structure 110 from the monomer 620, which may self-propagate in a 3D pattern. In a number of variations, the light input may be fixed in size and may be fixed in location (or stationary with respect to the mask). As such, the propagated polymer optical waveguides 26 form the microtruss structure 110. In a number of variations, the photo-polymer material 130 or monomer 620 may undergo a refractive index change during the polymerization process that may lead to the formation of polymer optical waveguides 26. In a number of variations, if a monomer 620 of photo-polymer material 130 that may be photo-sensitive may be exposed to light (e.g., UV light) under the right conditions, the initial area of polymerization (e.g., a small circular area) may “trap” the light and guide it to the tip of the polymerized region, further advancing that polymerized region. In a number of variations, the collimated light source 600 may have a wavelength between about 200 nm and about 500 nm. In a number of variations, this process may continue, leading to the formation of a waveguide 26 structure with approximately the same cross-sectional dimensions along its entire length. In a number of variations, this process may continue, leading to the formation of a waveguide 26 structure with differing cross-sectional dimensions along its entire length.

In a number of variations, the formation of a polymer optical waveguide 26 requires an index of refraction change between the liquid monomer 620 and the solid polymer 110 (618). In a number of variations, to enable self-propagation of the polymer optical waveguide 26, the microtruss polymer structure 110 may be as transparent as possible to the wavelength(s) of the light that may be used to generate free radicals and induce polymerization. In a number of variations, to enable self-propagation of the polymer optical waveguide 26, the microtruss polymer structure 110 and resulting panel 10 may be a variety of colors including, but not limited to, blue, green, red, yellow, orange, purple, tan, cyan, black, white, multicolored, shades thereof, or may be another color. In a number of variations, the polymerization of waveguides 26 to form a three-dimensional open-cellular microtruss polymer structure 110 which may have a reactivity such that the reaction may stop when the light exposure may be off to avoid over-curing of the monomer 620 that surrounds the polymer optical waveguide 26.

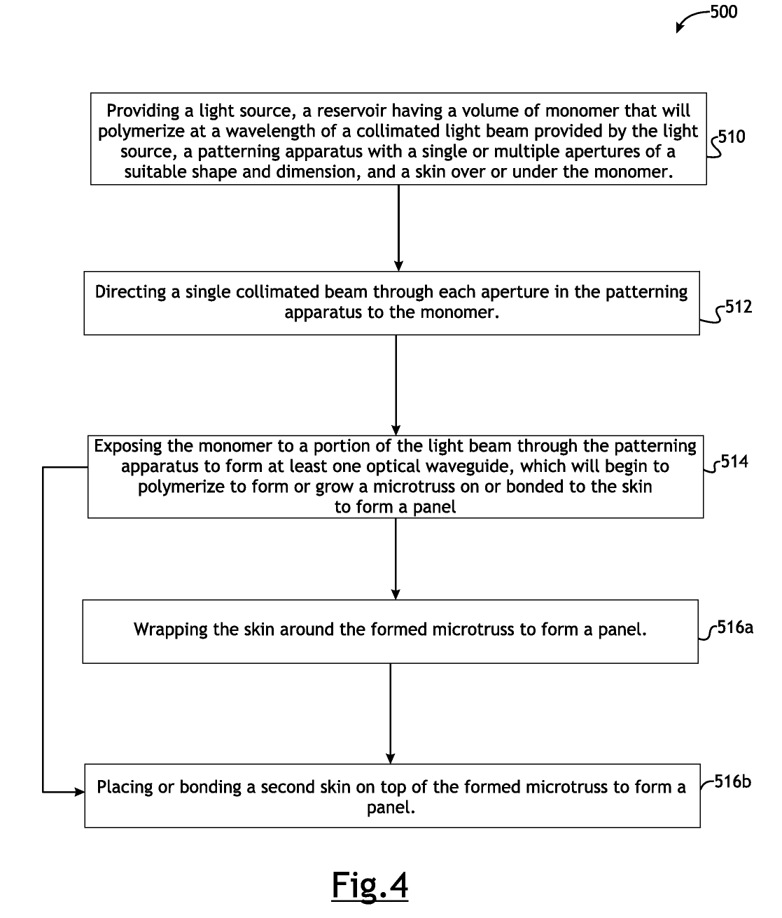

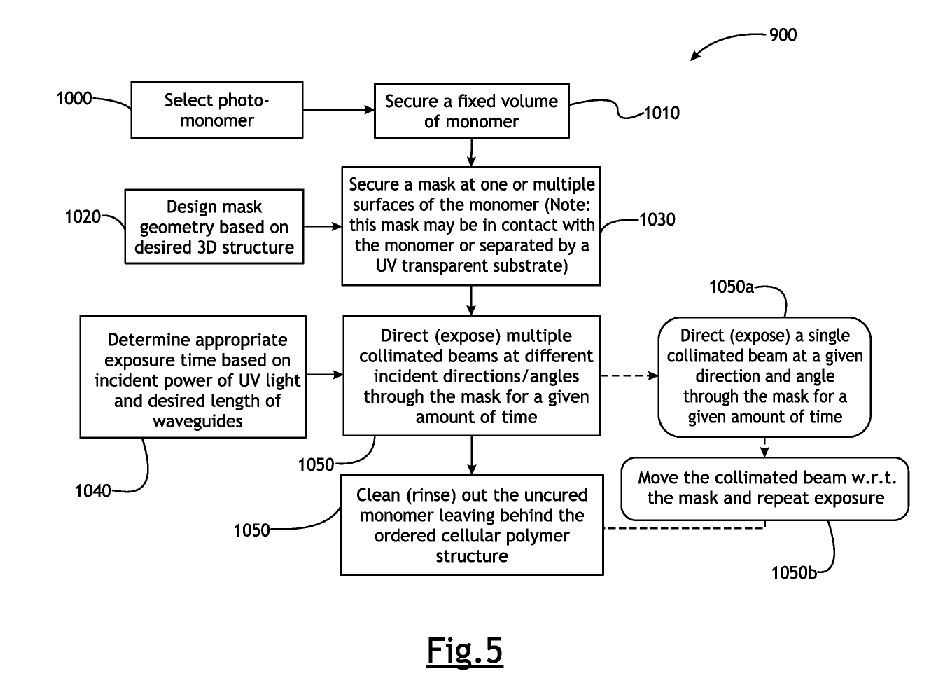

In a number of variations, the microtruss 16 may be formed according to a system 550 and/or method 500. As shown in FIGS. 4-5, the system or method 500 may include block 510 of providing a light source (e.g., a collimated light source) 600, a reservoir (e.g., a mold) 610 having a volume of monomer 620 that may polymerize at a wavelength of a collimated light beam provided by the light source 600, and a patterning apparatus 630 (e.g., a mask) with a single or multiple apertures 640 (e.g., open area, hole) of a suitable shape and dimension. In a number of variations, the patterning apparatus 630 may be made of a lightweight, flexible, and opaque material such as PET (polyethylene terephthalate) film. In a number of variations, the aperture(s) 640 may be in a shape of a triangle, a pentagon, a hexagon, a polygon, an oval, a star, or may be another shape depending on the appropriate application of the microtruss 16. In a number of variations, the patterning apparatus 630 may be 3-D in shape to form a 3-D microtruss interior 14. In a number of variations, in block 512, a single collimated beam may be directed through each aperture 640 in the patterning apparatus 630 to the monomer 620. In a number of variations, between the patterning apparatus 630 and the monomer 620, there may be a substrate 650. In a number of variations, the substrate 650 may be placed over or under the monomer 620. In a number of variations, the substrate 650 may be composed of a material, such as glass, Mylar, and other suitable materials that may transmit the incident light beam to the monomer 620. In a number of variations, the substrate 650 may be the skin 12 and may be made of other materials listed. In a number of variations, the substrate or skin 650, 12 may be substantially transparent to the incident light beam. In a number of variations, in block 514, on the surface of the monomer 620, in the area exposed to a portion of the light beam, at least one optical waveguide 26 may begin to polymerize to form or “grow” a microtruss 16. In a number of variations, the microtruss 16 may grow on, form on, bond, or attach to the substrate or skin 650, 12 to form a panel 10. Optionally, in a number of variations, in block 516a, the substrate or skin 650 or skin 12 may be wrapped around or placed over the formed microtruss 16 to form a panel 10. Optionally, in a number of variations, in block 516b, a second substrate or skin 650′ or second skin 12′ may be placed on top of the formed microtruss 16 to form a panel 10. In a number of variations, the microtruss 16 may bond to the substrate 650 or skin 12. In a number of variations, the substrate 650, 650′ or skin 12, 12′ may be 3-D in shape to form a 3-D panel 10. In a number of variations, the microtruss 16 may be placed within two different skins 12, 12′ which may have been bonded to or grown on opposing sides of the microtruss structure 110. In a number of variations, the skins 12, 12′ may be attached or bonded either before or after the microtruss structure 110 may be formed into a particular curvature or shape. In a number of variations, the attachment of the skins 12, 12′ to the microtruss structure 110 creates a sandwich structure, which may have additional strength, stiffness, and thermal conductivity properties. In a number of variations, the skin 12 may bond to the microtruss 16 as a result of the curing of the microtruss 16. In a number of variations, the skin 12 may bond to the microtruss 16 using an adhesive (not shown). In a number of variations, the adhesive may be a UV cure adhesive. In a number of variations, the sealing layer 19 may aid in bonding the microtruss 16 to the skin 12. In a number of variations, the sealing layer 19 may include the adhesive. In a number of variations, the sealing layer 19 may prevent the microtruss 16 or adhesive from seeping into the skin 12 during the formation methods.

In a number of variations according to FIG. 5, a method 900 is shown. In a number of variations, the method 900 may make a 3-D panel 10 from a microtruss 16 and at least one skin 12. As illustrated in FIG. 5, a photo-monomer 130/620 may be selected in block 1000. In a number of variations, in block 1010, a volume of the selected photo-monomer 620 may be secured (e.g., in a reservoir or mold 610). In a number of variations, a mask 630 geometry may be designed based on a desired 3D structure in block 1020. In a number of variations, a patterning apparatus 630, such as a mask having the designed geometry, may be secured in block 1030. In a number of variations, the secured mask 630 may have at least one aperture 640 between at least one collimated light source 600 and the volume of the selected photo-monomer 620. In a number of variations, the mask 630 may be in contact with the monomer 620 or separated by a substrate 650, or skin 12. In block 1040, an appropriate exposure time may be determined based on incident power of a collimated light beam from the at least one collimated light source (e.g., an incident power of an UV light) 600 and a desired length of one or more waveguides 26. In a number of variations, The collimated light beam from the at least one collimated light source 600 may be directed to the mask 630 for a period of exposure time so that a portion of the collimated beam passes through the mask 630 and may be guided by the at least one aperture 640 into the photo-monomer 620 to form at least one waveguide 26 through a portion of the volume of the photo-monomer 650. In a number of variations, the at least one waveguide 26 may have a cross sectional geometry substantially matching the designed aperture geometry on the mask 630. In a number of variations, as shown in block 1050, multiple collimated beams at different incident directions and/or angles may be directed through the mask 630 for a given amount of time. In a number of variations, as shown in blocks 1050 a, a single collimated beam at a given direction and angle may be directed through the mask 630 for a given amount of time. In a number of variations, at block 1050 b, the collimated light beam may be moved with respect to the mask 630 and the exposure may be repeated. In a number of variations, a panel 10 may be formed from the microtruss 16 resulting from the exposed waveguides 26, and the skin 12.

In a number of variations, the index of refraction change between the polymer and monomer may “trap” and “focus” the light in the polymer and guide the polymerization process. In a number of variations, due to this self-guiding/self-focusing effect, the polymerized waveguide 26 may form with an approximately constant cross-section and a length much greater than the cross-sectional dimensions. In a number of variations, the direction in which this polymer optical waveguide 26 may grow may be dependent on the direction of the incident beam 600. In a number of variations, the cross-section of the polymer optical waveguide 26 may be dependent on the shape and dimensions of the incident collimated beam 600, which in turn may be dependent on the shape and dimensions of the aperture 640 in the patterning apparatus 630. In a number of variations, this may allow the microtruss 16 to have a curved and planar portion and/or varying width in at least two places. In a number of variations, the length to which the polymer optical waveguide 26 may “grow” may be dependent on a number of parameters including the size, intensity, and exposure time of the incident beam, as well as the light absorption/transmission properties of the photo-polymer material 130. In a number of variations, the time in which it takes to form a polymer optical waveguide 26 may depend on the kinetics of the polymerization process.

In a number of variations, different thicknesses of the microtruss 16 may be achieved by filling the reservoir 610 with monomer 620 to a desired height and watching the polymer optical waveguides 26 grow upward towards the light once a light source 600 may be applied, terminating at the free surface of the monomer 620 in the mold 610. In a number of variations, the patterning apparatus or mask 630 may be configured to move the reservoir 610 to move the aperture 640, the monomer 620 and the growing waveguides 26 through the light or heat 600 exposure area to form a continuous microtruss 16. In a number of variations, the panel 10 and/or microtruss 16 may be made in a fabrication process according to the non-limiting method shown in U.S. application Ser. No. 11/580,335. In a number of variations, the panel 10 and/or microtruss 16 may be made in a continuous or batch fabrication process according to the non-limiting method shown in U.S. application Ser. No. 12/835,276.

In a number of variations, multiple apertures 640 could be used to form a plurality of waveguides 26 with the spacing between the waveguides 26 corresponding to the pattern of the plurality of apertures 640. In a number of variations, The aperture 640 spacing, i.e., distance between apertures 640 in the mask 630, and the number of waveguides 26 formed from each of the apertures 640 may determine the open volume fraction (i.e. open space) of the formed ordered 3D microtruss 16 structure 110 (or the formed open-cell polymer microtruss 16 structure 110). In a number of variations, a 3D network (or microtruss structure 110) may be formed because the intersecting polymer optical waveguides 26 may polymerize together, but may not interfere with waveguide 26 propagation.

In a number of variations, as shown in FIGS. 7A1-7C3, the panel 10 may be formed by varying methods. In a number of variations, as shown in FIGS. 7A1-7A10, a mold 700 may be used to a desired shape of the panel 10. In a number of variations, in step 7A1, a mold 700 is first introduced. In a number of variations, in step 7A2, a skin 12 is introduced and may be placed in the mold 700. In a number of variations, the skin 12 may be vacuum or blow molded into the mold 700 to fit the desired shape or may be formed a different way, as shown in FIG. 7A3. In a number of variations, in step 7A4, a monomer 620 may be introduced into the mold 700 against the skin 12 in a mass of monomer 620 material. In a number of variations, a monomer 620 may be placed in the mold 700 against the skin 12 along its length via second mold or conformal mask mold 700′, which may also be placed against the monomer 620 and apply the monomer 620 against the skin 12. In a number of variations, the conformal mask mold 700′ may be translucent to allow the fixed light or heat input 600 to irradiate the monomer 620. In a number of variations, in steps 7A5-7A6, a conformal mask mold 700′ may be placed against the monomer 620 to spread the monomer 620 along the face of the skin 12. In a number of variations a second skin 12′ may be applied against the monomer 620 through incorporation into any of the methods recited. In a number of variations, the conformal mask mold 700′ may be translucent to allow the fixed light or heat input 600 to irradiate the monomer 620. In a number of variations, in step 7A7, a fixed light or heat input 600 or UV light 660′ may be used to irradiate the monomer 620 and form the microtruss 16 along the length of the mold 700 per the method described above to form a panel 10. In a number of variations, the monomer 620 may be pre-cured. In a number of variations, in step 7A8, the monomer 620 may be cleaned out from the conformal mask mold 700′ on top of the formed microtruss 16. In a number of variations, in step 7A9, the monomer 620 may be irradiated again. In a number of variations, the monomer 620 may be post-cured. In a number of variations, a second skin 12′ may be placed over the microtruss 16. In a number of variations, in step 7A10, the panel 10 may be removed from the mold 700 wherein the panel includes at least one skin 12 and an interior 14 comprising a microtruss 16. In a number of variations, as shown in FIGS. 7B1 and 7B2, the skin 12 may be placed in the mold 700 and the monomer may be placed on the skin 12 and irradiated by the fixed light or heat input 600 or UV light 660′ to form a panel 10 as shown in the method of FIGS. 7A1-7A10, however, in a number of variations, the monomer 620 may be partially cured and this partially cured microtruss core 17 may be used to form an intermediate panel 13. In a number of variations, the intermediate panel 13 may be removed from the mold 700 and vacuum or blow molded, or may be formed another way, into a second mold 710 as shown in FIGS. 7B3 and 7B4. In a number of variations, the materials for skin(s) 12 may be chosen such that they are easily blow/vacuum formable and the partially cured microtruss core 17 may also be easily deformed as it may have a low modulus and a high failure strain at the elevated temperature of the blow/vacuum forming process. In a number of variations, the skin 12 may include a plurality of holes 25 to aid in the blow/vacuum forming process. In a number of variations, after the blow/vacuum forming process is complete, the microtruss core 17 may be further irradiated by fixed light or heat input 600 or UV light of the appropriate wavelength or heated to an appropriate temperature to fully cure the microtruss core 17 in its new configuration, and thus complete the forming of the panel 10 as shown in FIG. 7B5. In a number of variations, the fixed light or heat input 600 or UV light may emit heat to cause the intermediate panel 13 to form into the panel 10. In a number of variations, the panel 10 may be cooled after heat is applied to solidify the microtruss 16. In a number of variations, as shown in FIGS. 7C1-7C3, the mold 700 may form the intermediate panel 13 as shown in FIGS. 7B1-7B5, however, the microtruss core may be fully cured in the intermediate panel 13. In a number of variations, as shown in FIGS. 7C2-7C3 the intermediate panel 13 may then be heated or irradiated by the fixed light or heat input 600 or UV light 660′ to beyond the glass transition temperature (Tg) of the microtruss core 17 when it is then placed in the second mold 710 to fit a desired shape. In a number of variations, the microtruss core 17 may have a significantly lower modulus and may have a higher failure strain above its Tg. In a number of variations, the skin materials 12 may also be chosen such that they are suitable for forming at the temperature to which the core 17 is heated. In a number of variations, the entire intermediate panel 13 is then formable at this temperature. In a number of variations, this panel 13 may then be blow or vacuum molded to fit the shape of the second mold 710. In a number of variations, the intermediate panel 13 may then be cooled once it fits the shape of the second mold 710 to form the panel 10. The glass transition temperature may vary depending on the components of the skin 12 and monomer 620 used. In a number of variations, using any of these methods, a second skin 12′ may be placed over the microtruss to form a panel 10 with two skins and the microtruss 12 as an interior 14 as shown in FIGS. 1 and 2.

In a number of variations, a sealing layer 19 may be placed between the microtruss 16 and the skin 12 as shown in FIGS. 7C1-7C3. In a number of variations, the sealing layer may prevent the monomer from seeping into the skin 12 during the fabrication process, it may promote better bonding between the skin 12 and the microtruss core 17, or it may facilitate the formation of the finished trim panel 12 in some other way. In a number of variations, the microtruss 16 may grow on, form on, bond, or attach to the sealing layer 19. In a number of variations, the sealing layer 19 may comprise at least one of an epoxy, a polyurethane, a polyimide, a cyanoacrylate, a urethane, a acrylic, a rubber, a phenolic resin, a formaldehyde resin, a phenol-formaldehyde resine, a styrene, a styrene-butadiene, a vinyl resin (such as, but not limited to, polyvinyl acetate, polyvinyl butyral, polyvinyl ether, polyvinyl formal, polyvinyl ether, or polyvinyl chloride), a acrylic resin, a phenoxy, a polyamide, a polyester, a ethylene acrylic acid copolymer, ethylene vinyl acetate, a polysulfide, a silicone polymer, a cyanoacrylate, a cement, a glycerine, a nitride, an oxide, a polyolefin polymer, a polyester resin, a polyimide, a polyamide, a polybenzimidazole, a polyquinoxaline, a polyethylenimine, a urea, a melamine, a acrylonitrile-butadiene, a polyisobutylene, a styrene-diene-styrene, a polychloroprene, combinations thereof, or may be another type. In a number of variations, the sealing layer 19 may be applied to the skin 12 or it may be developed in-situ by suitable surface modifications of the skin. Not all skins require a sealing layer. In a number of variations, the microtruss 16 may be used to meet a number of applications within panels 10 according to numerous parameters including, but not limited to 1) the angle and pattern of the polymer optical waveguides 26 with respect to one another, 2) the packing, or relative density of the resulting cell structure (or the open volume fraction), and 3) the cross-sectional shape and dimensions of the polymer optical waveguides 26. In a number of variations, the microtruss 16 thickness may range from 10 microns to 5 mm depending on the design criteria. In a number of variations, the length of the waveguide 26 between waveguide nodes 120 of interpenetrating waveguides 26 may be between 5 and 15 times the thickness. In a number of variations, the microtruss 16 may be grown in a way in which the resulting panel 10 may have differing material density across its shape or length depending on its application. In a number of variations, the microtruss 16 and/or panel 10 may have changing thickness throughout. In a number of variations, the microtruss 16 and/or panel 10 may have changing geometry throughout to map regions of higher or lower stiffness and strength according to the panel 10 application.

In a number of variations, the microtruss 16 may be coated with a material enhancer 170 that may comprise a metal material selected from the group comprising nickel (Ni), copper (Cu), gold (Au), silver (Ag), ruthenium (Ru), platinum (Pt), rhodium (Rh), cobalt (Co), iron (Fe), zinc (Zn), titanium (Ti), aluminum (Al), or combinations thereof. In a number of variations, coating a microtruss structure 110 with a metal material may increase the strength, stiffness, and thermal conductivity of the microtruss structure 110. In a number of variations, the microtruss 16 may be coated with an enhancer 170 that may comprise a ceramic material selected from the group comprising silicon carbide, silicon nitride, hafnium carbide, chromium carbide, boron nitride, boron carbide, aluminum oxide, titanium diboride, titanium nitride, zirconium dioxide, titanium carbide, titanium carbonitride, tantalum carbide, tantalum nitride, or combinations thereof. In a number of variations, coating a microtruss structure 110 with a metal material may increase the strength, stiffness, and thermal conductivity of the microtruss structure 110. The enhancer 170 may be coated using a number of processes including, but not limited to, electroplating, metal casting, gel casting, slip casting, sol-gel, chemical vapor deposition, carbide reactions, or may be formed another way.

In a number of variations, the panel 10 may comprise an attachment component 20. In a number of variations, the attachment component 20 may comprise a male attachment 18 including, but not limited to, bolt, fastener, buckle, button, cable tie, clamp, clip, clutch, flange, frog, grommet, latch, nail, peg, pin, hook and loop fastener, rivet, screw anchor, snap fastener, staple, stitch, strap, threaded fastener, tie, toggle bolt, zipper, wedge anchor, or may be another type. In a number of variations, the male attachment 18 may be secured to the panel 10 after formation according to known methods. In a number of variations, the attachment component 20 may comprise a female attachment 18 including, but not limited to, a hole, crevice, slot, edge, recess, or may be another type. In a number of variations, the female attachment 18 may be formed in the panel 10 after formation according to known methods. In a number of variations, the female attachment 18 may be the result of the patterning apparatus 630.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include product comprising a panel comprising a skin and an interior wherein the interior comprises a microtruss.

Variation 2 may include a product as set forth in Variation 1 wherein the panel comprises an interior panel of a vehicle.

Variation 3 may include a product as set forth in any of Variations 1-2 wherein the skin comprises a fabric, leather, or composite laminate.

Variation 4 may include a product as set forth in any of Variations 1-3 wherein the microtruss comprises at least one of a polymeric or metallic material.

Variation 5 may include a product as set forth in any of Variations 1-4 wherein the microtruss is uniform throughout.

Variation 6 may include a product as set forth in any of Variations 1-5 wherein the panel has at least one curved portion and at least one planar portion.

Variation 7 may include a product as set forth in any of Variations 1-6 wherein the panel comprises at least one attachment component.

Variation 8 may include a product as set forth in Variations 1-7 wherein the interior is bonded or grown on to the skin.

Variation 9 may include a product as set forth in any of Variations 1-8 wherein the interior has a varying thickness throughout.

Variation 10 may include a product as set forth in any of Variations 1-9 further comprises a sealing layer that lies between the interior and the skin.

Variation 11 may include a method including providing a skin; and forming an interior comprising a microtruss on the skin to form a panel.

Variation 12 may include a method as set forth in Variation 11 further comprising, wrapping the skin or placing a second skin over the interior.

Variation 13 may include a method as set forth in any of Variations 11-12 wherein the skin comprises a fabric, leather, or composite laminate.

Variation 14 may include a method as set forth in any of Variations 11-13 wherein the microtruss comprises at least one of a polymeric or metallic material.

Variation 15 may include a method as set forth in any of Variations 11-14 wherein the panel is formed in a mold.

Variation 16 may include a method as set forth in any of Variations 11-15 wherein the panel has at least one curved portion and at least one planar portion.

Variation 17 may include a method as set forth in any of Variations 11-16 wherein the interior is bonded to or grown on the skin.

Variation 18 may include a method as set forth in any of Variations 11-17 wherein the interior has a varying thickness throughout.

Variation 19 may include a method as set forth in any of Variations 11-18 further comprises a sealing layer that lies between the interior and the skin.

Variation 20 may include a method including providing a mold; placing a skin inside the mold; placing a photo curable monomer over the skin; and irradiating the monomer to form a microtruss layer on the skin to form a panel.

Variation 21 may include a method, and/or a product as set forth in any of Variations 1-20 wherein the panel is one of a trim panel, cover, side panel, exterior panel, upper t-bone, upper interior, or may be another type.

Variation 22 may include a method, and/or a product as set forth in any of Variations 1-21 wherein the microtruss is uniform throughout.

Variation 23 may include a method, and/or a product as set forth in any of Variations 1-22 wherein the polymeric material is defined by a plurality of self-propagating polymer optical waveguides.

Variation 24 may include a method, and/or a product as set forth in any of Variations 1-23 wherein the interior has a width of less than 1 millimeter.

Variation 25 may include a method, and/or a product as set forth in any of Variations 1-24 wherein the skin has a width of less than 0.5 millimeters.

Variation 26 may include a method, and/or a product as set forth in any of Variations 1-25 wherein the skin comprises a material including, but not limited to, plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, or combinations thereof

Variation 26 may include a method, and/or a product as set forth in any of Variations 1-25 wherein the photo-polymer material or monomer comprises a plurality of (a) unsaturated molecules, (b) a molecule having a structure of R—X—H (e.g., X═O, S, N), and (c) a photoinitiator.

Variation 27 may include a method, and/or a product as set forth in any of Variations 1-26 wherein the molecule having a structure of R—X—H (e.g., X═O, S, N) is between about 3% and about 97% by weight of the monomeric formulation

Variation 28 may include a method, and/or a product as set forth in any of Variations 1-27 wherein the unsaturated molecules comprise C═X2 double bonds or C═X2 triple bonds, wherein X2 may be selected from a group comprising C, N, O, and S.

Variation 29 may include a method, and/or a product as set forth in Variation 28 wherein the substitution on the multiple bonds are any atoms such as H, F and Cl, or groups such as alkyl groups, esters, amine groups, hydroxyl groups and CN. In a number of variations, one or more of these double bonds or triple bonds may be present in the unsaturated molecules

Variation 30 may include a method, and/or a product as set forth in any of Variations 1-29 wherein each of the unsaturated molecules (a) comprises one or more different vinyl groups comprising at least one of ethynyl, cyanide, vinyl ether, vinyl ester, vinyl amides, vinyl triazine, vinyl isocyanurate, acrylate, methacrylate, diene, triene, pentaerythritol tetraacrylate; 2, 4, 6-triallyloxy-1, 3, 5-triazine; triallyl-1, 3, 5-triazine-2, 4, 6-trione; and tricyclohexane.

Variation 31 may include a method, and/or a product as set forth in any of Variations 1-30 wherein the molecule having a structure of R—X—H comprises an organic group comprising a part of an alkyl group, ester group, amine group, and/or hydroxyl group.

Variation 32 may include a method, and/or a product as set forth in any of Variations 1-31 wherein the photoinitiator is more than 0% and less than about 10% of total weight of the monomeric formulation.

Variation 33 may include a method, and/or a product as set forth in any of Variations 1-32 wherein the photoinitiator is selected from a group comprising 2, 2-dimethoxy-2-phenylacetophenone; 2-hydroxy-2-methylpropiophenone; camphorquinone; benzophenone; and benzoyl peroxide.

Variation 34 may include a method, and/or a product as set forth in any of Variations 1-33 wherein monomer further comprises a free radical inhibitor comprising hydroquinone, methylhydroquinone, ethylhydroquinone, methoxyhydroquinone, ethoxyhydroquinone, monomethylether hydroquinone, propylhydroquinone, propoxyhydroquinone, tert-butylhydroquinone, and n-butylhydroquinone.

Variation 35 may include a method, and/or a product as set forth in any of Variations 1-34 wherein the free radical inhibitor is between 0-3% by weight of the total monomeric material composition.

Variation 36 may include a method, and/or a product as set forth in any of Variations 1-35 wherein the microtruss lacks interior boundaries.

Variation 37 may include a method, and/or a product as set forth in any of Variations 1-36 wherein the polymer structure and resulting panel are a variety of colors including, but not limited to, blue, green, red, yellow, orange, purple, tan, cyan, black, white, multicolored, or shades thereof.

Variation 38 may include a method, and/or a product as set forth in any of Variations 1-37 wherein method comprises providing a light source, a reservoir having a volume of monomer that may polymerize at a wavelength of a collimated light beam provided by the light source, a patterning apparatus with a single or multiple apertures of a suitable shape and dimension and a skin over or under the monomer; directing a single collimated beam through each aperture in the patterning apparatus to the monomer; exposing the monomer to a portion of the light beam through the patterning apparatus to form at least one optical waveguide, which may begin to polymerize to form or grow a microtruss on or bonded to the skin; and wrapping the skin around the formed microtruss to form a panel or placing or bonding a second skin on top of the formed microtruss to form a panel.

Variation 40 may include a method, and/or a product as set forth in any of Variations 1-39 wherein the patterning apparatus comprises a lightweight, flexible, and opaque material such as PET (polyethylene terephthalate) film.

Variation 41 may include a method, and/or a product as set forth in any of Variations 1-40 wherein the aperture(s) is in the shape of a triangle, a pentagon, a hexagon, a polygon, an oval, or a star.

Variation 42 may include a method, and/or a product as set forth in any of Variations 1-41 wherein the patterning apparatus is a 3-D in shape to form a 3-D microtruss interior.

Variation 43 may include a method, and/or a product as set forth in any of Variations 1-42 wherein skin bonds to the microtruss as a result of the curing of the process.

Variation 44 may include a method, and/or a product as set forth in any of Variations 1-43 wherein the skin bonds to the microtruss using an adhesive comprising a UV adhesive.

Variation 45 may include a method, and/or a product as set forth in any of Variations 1-44 wherein the reservoir, aperture, monomer, waveguide, or patterning apparatus may be moved to form a continuous microtruss.

Variation 46 may include a method, and/or a product as set forth in any of Variations 1-45 wherein the microtruss has an open-cell polymer microtruss structure

Variation 47 may include a method, and/or a product as set forth in any of Variations 1-46 wherein the microtruss thickness may range from 10 microns to 5 mm depending on the design criteria.

Variation 48 may include a method, and/or a product as set forth in any of Variations 1-47 wherein the microtruss and/or panel may have changing geometry throughout to map regions of higher or lower stiffness and strength according to the panel application.

Variation 49 may include a method, and/or a product as set forth in any of Variations 1-48 wherein microtruss is coated with a material enhancer that comprises a metal material selected from the group comprising nickel (Ni), copper (Cu), gold (Au), silver (Ag), ruthenium (Ru), platinum (Pt), rhodium (Rh), cobalt (Co), iron (Fe), zinc (Zn), titanium (Ti), aluminum (Al), or combinations thereof.

Variation 50 may include a method, and/or a product as set forth in any of Variations 1-49 wherein the microtruss is coated with a material enhancer that comprises a ceramic material selected from the group comprising silicon carbide, silicon nitride, hafnium carbide, chromium carbide, boron nitride, boron carbide, aluminum oxide, titanium diboride, titanium nitride, zirconium dioxide, titanium carbide, titanium carbonitride, tantalum carbide, tantalum nitride, or combinations thereof.

Variation 51 may include a method, and/or a product as set forth in any of Variations 1-50 wherein the enhancer is coated using a number of processes including electroplating, metal casting, gel casting, slip casting, sol-gel, chemical vapor deposition, or carbide reactions.

Variation 52 may include a method, and/or a product as set forth in any of Variations 1-51 wherein the attachment component comprises a male attachment comprising a bolt, fastener, buckle, button, cable tie, clamp, clip, clutch, flange, frog, grommet, latch, nail, peg, pin, hook and loop fastener, rivet, screw anchor, snap fastener, staple, stitch, strap, threaded fastener, tie, toggle bolt, zipper, or wedge anchor.

Variation 53 may include a method, and/or a product as set forth in any of Variations 1-52 wherein the attachment component comprises a female attachment comprises a hole, crevice, slot, edge, or recess.

Variation 54 may include a method, and/or a product as set forth in any of Variations 1-53 wherein the sealing layer comprises at least one of an epoxy, a polyurethane, a polyimide, a cyanoacrylate, a urethane, a acrylic, a rubber, a phenolic resin, a formaldehyde resin, a phenol-formaldehyde resine, a styrene, a styrene-butadiene, a vinyl resin (such as, but not limited to, polyvinyl acetate, polyvinyl butyral, polyvinyl ether, polyvinyl formal, polyvinyl ether, or polyvinyl chloride), a acrylic resin, a phenoxy, a polyamide, a polyester, a ethylene acrylic acid copolymer, ethylene vinyl acetate, a polysulfide, a silicone polymer, a cyanoacrylate, a cement, a glycerine, a nitride, an oxide, a polyolefin polymer, a polyester resin, a polyimide, a polyamide, a polybenzimidazole, a polyquinoxaline, a polyethylenimine, a urea, a melamine, a acrylonitrile-butadiene, a polyisobutylene, a styrene-diene-styrene, a polychloroprene, combinations thereof, or may be another type. In a number of variations, the sealing layer 19 may be applied prior to, during, or after formation of the microtruss 16. In a number of variations, the sealing layer 19 may be applied to the skin 12 or microtruss 16.

The above description of select examples of the invention is merely exemplary in nature and, thus, variations or variants thereof are not to be regarded as a departure from the spirit and scope of the invention.

What is claimed is:

1. A product comprising: a panel comprising a skin and an interior wherein the interior comprises a microtruss.

2. A product as set forth in claim 1 wherein the panel comprises an interior panel of a vehicle.

3. A product as set forth in claim 1 wherein the skin comprises at least one of a fabric, leather, or composite laminate.

4. A product as set forth in claim 1 wherein the microtruss comprises at least one of a polymeric or metallic material.

5. A product as set forth in claim 1 wherein the microtruss is uniform throughout.

6. A product as set forth in claim 1 wherein the panel has at least one curved portion and at least one planar portion.

7. A product a set forth in claim 1 wherein the panel comprises at least one attachment component.

8. A product as set forth in claim 1 wherein the interior is bonded to or grown on the skin.

9. A product as set forth in claim 1 wherein the interior has a varying thickness throughout.

10. A product as set forth in claim 1 wherein the interior further comprises a sealing layer that lies between the microtruss and the skin.

11. A method comprising: providing a skin; and forming an interior comprising a microtruss on the skin to form a panel.

12. A method as set forth in claim 11 further comprising wrapping the skin or placing a second skin over the interior.

13. A method as set forth in claim 11 wherein the skin comprises at least one of a fabric, leather, or composite laminate.

14. A method as set forth in claim 11 wherein the microtruss comprises at least one of a polymeric or metallic material.

15. A method as set forth in claim 11 wherein the panel is formed in a mold.

16. A method as set forth in claim 11 wherein the panel has at least one curved portion and at least one planar portion.

17. A method as set forth in claim 11 wherein the interior is bonded to or grown on the skin.

18. A method as set forth in claim 11 wherein the interior has a varying thickness throughout.

19. A method as set forth in claim 11 wherein the interior further comprises a sealing layer that lies between the microtruss and the skin.

20. A method comprising:
providing a mold;
placing a skin inside the mold;
placing a photo curable monomer over the skin; and
irradiating the monomer to form a microtruss layer on the skin to form a panel.
